(19) United States
(12) Patent Application Publication
(10) Pub. No.: US 2014/0172909 A1
(43) Pub. Date: Jun. 19, 2014

(54) APPARATUS AND METHOD FOR PROVIDING SERVICE APPLICATION USING ROBOT

(71) Applicant: Electronics and Telecommunications Research Institute, Daejeon (KR)

(72) Inventors: Cheonshu PARK, Daejeon (KR); Min Su JANG, Daejeon (KR); Daeha LEE, Daejeon (KR); Jae Hong KIM, Daejeon (KR); Young-Jo CHO, Daejeon (KR); Jong-Hyun PARK, Daejeon (KR)

(21) Appl. No.: 13/913,875

(22) Filed: Jun. 10, 2013

(30) Foreign Application Priority Data
Dec. 17, 2012 (KR) 10-2012-0147600

(51) Int. Cl. G06F 17/30

(52) U.S. Cl. CPC G06F 17/30477
USPC 707/769

(57) ABSTRACT

An apparatus for providing a service application using a robot includes a sensing unit configured to generate environmental sensing information on the surrounding of a moving path of the robot and user state information; and a user circumstance determination unit configured to determine the circumstance and intention of a user to generate user recognition information, and searches and downloads a service application. Further, the apparatus includes a service provision unit configured to search service representation devices around the moving path of the robot and migrate a service corresponding to the service application to at least one of the searched service representation devices; and a user feedback management unit configured to manage feedback information corresponding to an interaction between the user and the robot.

### CROSS-REFERENCE TO RELATED APPLICATION(S)

The present invention claims priority of Korean Patent Application No. 10-2012-0147600, filed on Dec. 17, 2012, which is incorporated herein by reference.

### FIELD OF THE INVENTION

The present invention relates to an apparatus and method for providing a service application using a robot; and, more particularly, to a device and method of providing a service application using a robot capable of providing a service application required for each user by collecting surrounding environment information and user information in real time using the mobility of the robot, and capable of making various kinds of evaluation for the service application through feedback generated by human-robot interaction.

### BACKGROUND OF THE INVENTION

In recent years, various service applications are provided for smart phones, smart pads, PCs, and the like. In general, a service application is provided in such a way that a user searches, selects, and downloads a desired service application in an application store (hereinafter, referred to as app store). Since the service application, which is downloaded from the app store and used by the user, is performed in a given order and step by step, only a one-way limited user response can be fed back. This feedback mainly relates to evaluation for use, such as the number of downloads, user satisfaction, and user preference. Further, when the user searches a service application in the app store, there are many cases where unwanted service applications are also searched. In addition, there are many cases where the user simply selects a service application for which the number of downloads is large or user preference is high.

Accordingly, instead of a static process in which a user searches and selects a service application to be provided in an app store, a dynamic process in which the circumstance and the intention of the user can be recognized and a service application specialized for each user can be provided is required. Furthermore, it is necessary to make an evaluation for a service application through various kinds of feedback, as well as usability evaluation.

### SUMMARY OF THE INVENTION

In view of the above, the present invention provides an apparatus and method for providing a service application using a robot capable of providing the service application required for each user by collecting surrounding environment information and user information in real time using the mobility of the robot in a space where a robot service is possible and capable of making various kinds of evaluation including specific circumstances and use experience for a service application through feedback generated by human-robot interaction.

In accordance with a first aspect of the present invention, there is provided an apparatus for providing a service application using a robot. The device includes a sensing unit configured to generate environmental sensing information on the surrounding of a moving path of the robot and user state information; a user circumstance determination unit configured to determine the circumstance and intention of a user through the environmental sensing information and the user state information to generate user recognition information, and searches and downloads a service application in accordance with the user recognition information; a service provision unit configured to search service representation devices around the moving path of the robot and migrate a service corresponding to the service application to at least one of the searched service representation devices; and a user feedback management unit configured to manage feedback information corresponding to an interaction between the user and the robot (a human-robot interaction) while the service is being provided through the service representation device.

Further, the user circumstance determination unit may be configured to search the service application on the basis of metadata described in the service application.

Further, the metadata may comprise the domain of the service, device information relating to a device to be supported by the service application, content information relating to content included in the service application, execution information of the service, or the feedback information.

Further, the user circumstance determination unit may be configured to create a scenario of the human-robot interaction in accordance with the user recognition information and searches the service application on the basis of metadata.

Further, the service provision unit may be configured to search service representation devices corresponding to the service application in accordance with connection information and device information of the service representation devices on the basis of metadata.

Further, the service provision unit may be configured to compare and analyze the metadata and the device information of the service representation devices and selects the service representation device to which the service is provided.

Further, the user feedback management unit may be configured to manage a user response generated by the human-robot interaction and usability evaluation as the feedback information for the service application.

In accordance with a second aspect of the present invention, there is provided a method of providing a service application using a robot. The method includes generating environmental sensing information on the surrounding of a moving path of the robot and user state information; determining the circumstance and intention of a user through the environmental sensing information and the user state information to generate user recognition information; searching and downloading a service application in accordance with the user recognition information; searching service representation devices around the moving path of the robot; migrating a service corresponding to the service application to at least one of the searched service representation devices; and managing feedback information corresponding to an interaction between the user and the robot (a human-robot interaction) while the service is being provided through the service representation device.

Further, the searching a service application may comprise searching the service application using metadata described in the service application.

Further, the searching a service application may comprise creating a scenario of the human-robot interaction in accordance with the user recognition information on the basis of metadata.

Further, the searching service representation devices may comprise searching service representation devices corresponding to the service application in accordance with connection information and device information of the service representation devices on the basis of the metadata.

Further, the migrating a service may comprise comparing and analyzing the metadata and the device information of the service representation devices; and selecting a service representation devices to which the service is provided.

Further, the feedback information may comprise a user response generated by the human-robot interaction and usability evaluation.

In accordance with the apparatus and method of providing a service application using a robot of the present invention, service applications, which are required for service domains, such as education, silver care, care for the aged, home, office and sightseeing, capable of utilizing a robot are produced and distributed through a service application description language including metadata, a service application suitable for a user is searched by recognizing surrounding circumstances which change in real time along with the movement of the robot, and the service is provided through a service representation device, thereby increasing user satisfaction for a service application and providing a service application capable of meeting changing circumstances.

In accordance with the apparatus and method of providing a service application using a robot of the present invention, information generated by the human-robot interaction is used as feedback information, whereby as well as evaluation for use, such as the number of downloads, user satisfaction, and user preference of a service application, environments and circumstances required for the service application, and experience can be shared between the users. Therefore, it is possible to improve the utilization values of service applications and to use service applications in connection with different service domains to allow an application to various service domains.

### BRIEF DESCRIPTION OF THE DRAWINGS

The above and other objects and features of the present invention will become apparent from the following description of the embodiments given in conjunction with the accompanying drawings, in which:

FIG. 1 is a schematic diagram showing an apparatus for providing a service application using a robot in accordance with an embodiment of the present invention;

FIG. 2 is a block diagram showing the configuration of a robot 100 shown in FIG. 1; and

FIG. 3 is a flowchart showing a method of providing a service application using a robot in accordance with the embodiment of the present invention.

### DETAILED DESCRIPTION OF THE EMBODIMENTS

The invention is described in detail with reference to the accompanying drawings in connection with specific embodiments in which the present invention can be implemented. The embodiments are described in detail in order for those having ordinary skill in the art to practice the present invention. It will be understood that the various embodiments of the present invention differ from each other, but need not mutually exclusive. For example, specific shapes, structures, and characteristics described herein in relation to an embodiment can be implemented in another embodiment without departing from the spirit and scope of the present invention. It should be noted that position or arrangement of each element within each disclosed embodiment can be modified without departing from the spirit and scope of the present invention. Accordingly, the following detailed description should not be construed as limiting the present invention. The scope of the present invention, if properly described, is limited by only the appended claims and equivalent thereof. The same reference numerals are used throughout the drawings to refer to the same elements.

Hereinafter, in order that a person ordinarily skilled in the art can easily carry out the present invention, the embodiments of the present invention will be described in detail with reference to the accompanying drawings.

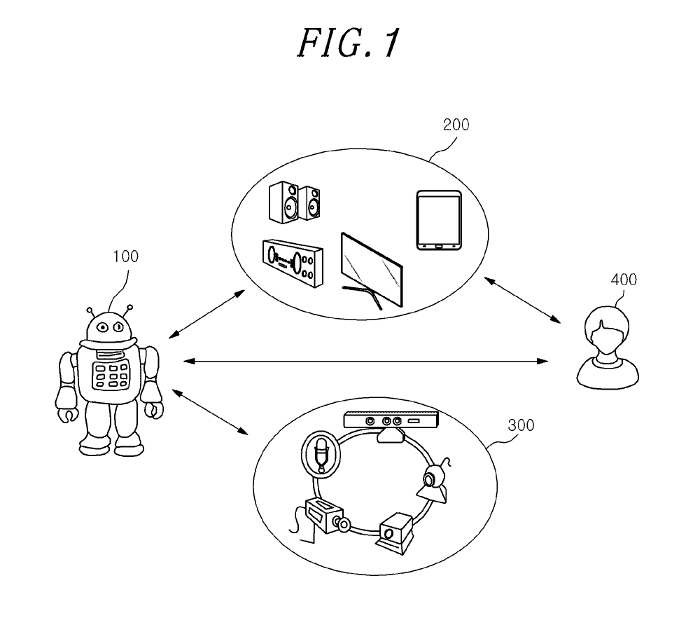

FIG. 1 is a schematic diagram showing an apparatus for providing a service application using a robot in accordance with an embodiment of the present invention.

Referring to FIG. 1, the apparatus for providing a service application of the embodiment includes a robot 100, a plurality of external sensing devices 200, and a plurality of service representation devices 300. In this regard, the robot 100 may be located at an educational facility, a town for the aged, home, an office, a public place, or the like, and may be a movable device. The robot 100 senses the circumstance and intention of a user 400 using information of the user 400 sensed by the external sensing devices 200 disposed around a moving path or information on the change in surrounding environments and feedback information from the user 400, searches service applications in an app store, in accordance with the circumstance and the intention of the user 400, and selectively downloads a service application.

The robot 100 determines whether or not there is a service representation device 300 which can represent a service to be provided by the downloaded service application from among the service representation devices 300 disposed around the moving path of the user 400. When the determination result shows that there is the service representation device 300 suitable for service representation, the robot 100 migrates the service in conformity with a recommended environment of the service representation device 300.

The service representation devices 300 may include a TV, an audio system, a screen, a PC, a smart phone, a smart pad, and the like. Each of the service representation devices 300 provide a service migrated from the robot 100 to the user 400. The external sensing devices 200 may include a camera, a microphone, an infrared sensor, a motion sensor, an environment sensor, and the like. The robot 100 can recognize the external sensing devices 200 and the service representation devices 300 using a universal plug and play (UPnP) protocol, a Bonjour program, or the like.

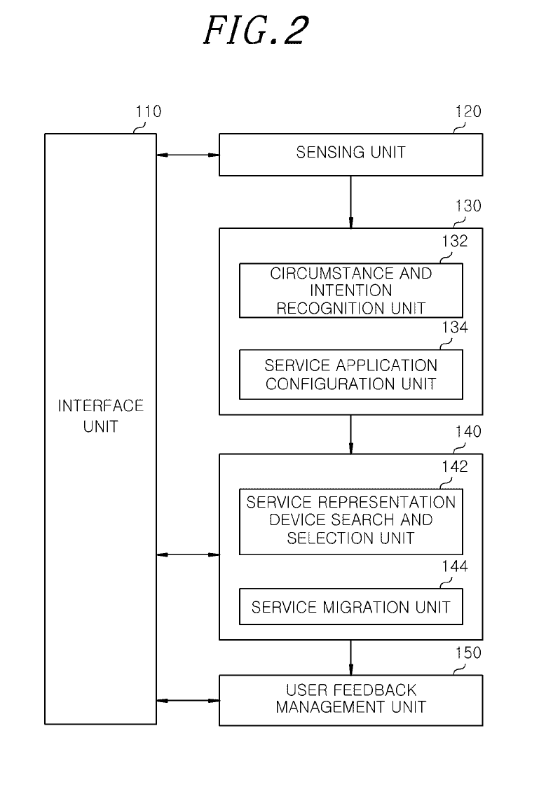

FIG. 2 is a block diagram of the robot 100 shown in FIG. 1.

Referring to FIG. 2, the robot 100 includes an interface unit 110, a sensing unit 120, a circumstance determination unit 130, a service provision unit 140, and a user feedback management unit 150. The interface unit 110 performs communication with the external sensing devices 200 and the service representation devices 300. The interface unit 110 may include a key input device which receives the selection relating to the execution and download of the service application from the user 400.

The sensing unit 120 senses surrounding circumstances and a user to generate environmental sensing information and user state information. Herein, the environmental sensing information may be space information corresponding to the moving path of the robot 100, and may be collected by an internal sensing device that may be embedded in the robot 100, for example, a camera, a microphone, a touch sensor, an infrared sensor, or the like, or may be transmitted from the external sensing devices 200. The user state information may include personal information, position information, face recognition information, voice, facial expression, motion (gesture), and emotional state.

The circumstance determination unit 130 determines the circumstance and the intention of the user in line with the environmental sensing information and the user state information, and selects and downloads at least one of a plurality of service applications to be provided in the app store, in accordance with the determined circumstance and intention of the user. To this end, the circumstance determination unit 130 includes a circumstance and intention recognition unit 132 and a service application configuration unit 134. The circumstance and intention recognition unit 132 determines the circumstance and the intention of the user in line with the environmental sensing information and the user state information to generate user recognition information.

The service application configuration unit 134 searches and downloads a service application using the environmental sensing information and the user recognition information on the basis of metadata described in the service application. In this case, the service application configuration unit 134 may selectively download a service application in accordance with a service domain, user profile information, and service application use information. The service application configuration unit 134 recommends the searched service application to the user and receives selection of download from the user.

In the embodiment of the present invention, the service domains may include all service domains, such as education, care for the aged, housing, company, and sightseeing, capable of utilizing a robot. It is preferable that, when executing the downloaded service application, the service application configuration unit 134 basically executes free contents included in the service application, and downloads and executes pay content in accordance with the selection of the user.

The service application in accordance with the embodiment of the present invention is produced in the form of a Web-based application, such as hypertext markup language 5 (HTML5), so as to describe independently in a specific operating system (OS) or a platform. The service applications or content in accordance with the service domains are registered in a cloud, a server, or the like. Here, contents connected to a service scenario may be stored in a physical space different from a service application or may have only connection information.

The service application description language describes metadata required for service application search. Metadata described in a service application includes a service domain, device information relating to a device which can be supported by a service application, resolution (described as SD, HD, Full-HD, 640*480, 720p, 1080p, or the like) which is supported by contents included in a service application, information about whether or not content can support a 3D screen, information relating to the conditions and circumstances for executing a service application, content information required for service search, and information relating to interaction feedback. In this regard, the contents include educational contents, the contents of the aged, contents for sightseeing, and the like, and the feedback information includes the inclination or response data of the user and is preferably described excluding personal security information about the user.

The service application description language in accordance with the embodiment of the present invention may include an interaction scenario for service execution, success/failure of service execution, circumstance information, detailed content information, connection information for connection to content, feedback information generated by interaction between the robot 100 and the user 400 (i.e., human-robot interaction) and the like. Each service application provides a flow based on a scenario, and contents required in the scenario are described through connection information. For example, as an educational service application of an educational domain, service applications, such as language arts, mathematics, and traditional fairy tales, may be defined, and each service application is constituted by content based on a scenario including metadata.

Referring back to FIG. 2, the service provision unit 140 recognizes the surrounding service representation devices 300 every a given period, and confirms services which can be represented by the service representation devices 300. Then, the service provision unit 140 compares and analyzes metadata of the downloaded service application and the services which can be represented by the service representation devices 300, selects an appropriate service representation device 300, and migrates the service to be provided by the service application in conformity with the service environment of the selected service representation device 300.

To this end, the service provision unit 140 includes a service representation device search and selection unit 142 and a service migration unit 144. The service representation device search and selection unit 142 receives connection information and device information of the service representation devices 300 and recognizes the connected service representation devices 300 around the moving path.

The service representation device search and selection unit 142 parses information relating to the connected service representation device 300 in the metadata of the downloaded service application, confirms whether or not the service representation device 300 can provide the service application, and selects the service representation device 300.

The service representation device search and selection unit 142 performs the mapping between device-related metadata of the service application and the function of the service representation device 300, and when both are similar or identical, determines that the service representation device 300 can provide the service application.

The service migration unit 144 determines the service environment of the service representation device 300 selected by the service representation device search and selection unit 142 and migrates a service to be provided by the service application in conformity with the service environment of the service representation device 300. For example, in the case of audio and video content, if an audio system and a screen are searched as the service representation devices 300, the service migration unit 144 provides audio content to the audio system and provides video content to the screen. When no surrounding service representation device 300 is searched, the service migration unit 144 may provide content using an internal service representation device of the robot 100, for example, a microphone or a display.

The user feedback management unit 150 generates feedback information depending on usability evaluation for the service application, the response of the user, and the like. The response of the user may include conversation between the user 400 and the robot 100, the touch, facial expression, and gesture of the user, and the like. In other words, in addition to usability evaluation, the user feedback management unit 150 can understand an environment or a circumstance, in which the satisfaction of the user is high, through the response of the user.

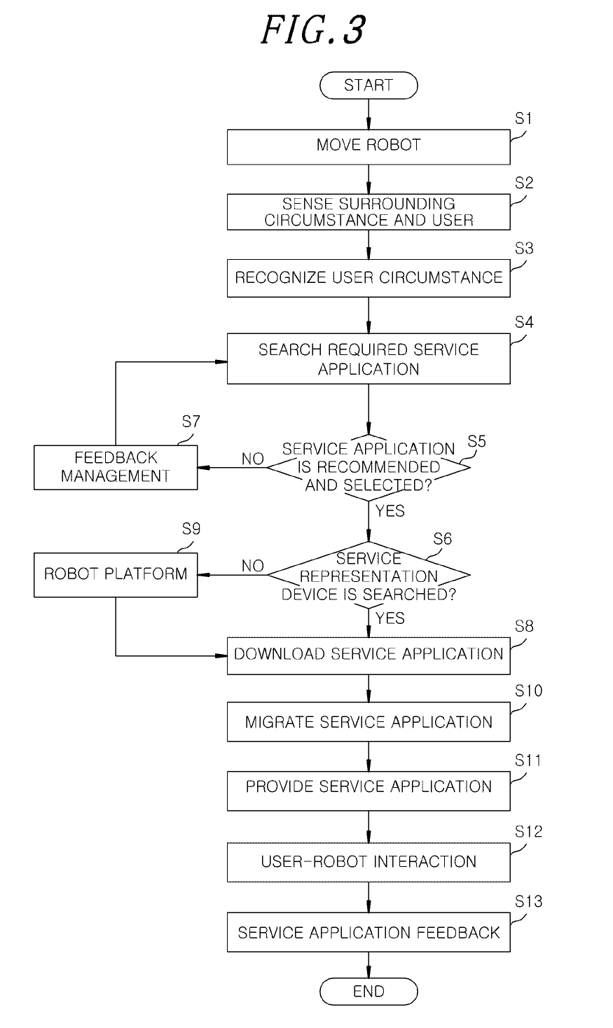

Hereinafter, a method of providing a service application using a robot in accordance with the embodiment of the present invention will be described with reference to FIG. 3.

FIG. 3 is a flow chart illustrating a method of providing a service application using a robot in accordance with the embodiment of the present invention.

Referring to FIG. 3, first, in operation S1, the robot 100 starts to move. Next, in operation S2, the sensing unit 120 senses the user 400, the external sensing devices 200 and the service representation devices 300 on the moving path of the robot 100 and generates environmental sensing information and user state information in operation S2. At this time, the sensing unit 120 may generate the environmental sensing information and the user state information by a sensor or the like in the robot 100.

The circumstance and intention recognition unit 132 determines the present circumstance of the user in accordance with the environmental sensing information and the user state information and generates user circumstance recognition information in operation S3. The service application configuration unit 134 then searches a service application required for the user at the present circumstance on the basis of metadata of the service application in operation S4.

Next, in operation S5, the service application configuration unit 134 recommends the service application to the user and determines whether or not the user selects the service application. When, in operation S5, the user selects the service application recommended by the service application configuration unit 134, the service representation device search and selection unit 142 searches the surrounding service representation devices 300 through the interface unit 110 in operation S6. At this time, it is preferable that the service representation device search and selection unit 142 executes operation S6 even for a service application which is automatically executed with no user selection.

Meanwhile, when, in operation S5, the user does not select the service application recommended by the service application configuration unit 134, the method goes to operation S7 where the user feedback management unit 150 determines that the service application is not suitable for the present circumstance of the user and generates and manages feedback information.

Next, in operation S6, when the service representation device search and selection unit 142 searches the compatible service representation device 300 on the basis of metadata, the service application is downloaded in operation S8. However, in operation S6, when the service representation device search and selection unit 142 does not search the service representation device 300, the method advances to in operation S9 where a representation device, such as a microphone or a display, in the robot 100 is searched in operation S9, and the method progresses to operation S8.

In operation S10, the service migration unit 144 migrates a service to be provided by the service application to the service representation devices 300 searched in operation S6. Subsequently, in operation S11, the service migration unit 144 provides the service to the user. At this time, while the user is receiving the service, interaction between the user 400 and the robot 100 (i.e., human-robot interaction) occurs in operation S12. For example, interaction, such as a conversation between the user and the robot 100, the touch of the user on the robot 100, change in the facial expression of the user, or change in the gesture of the user, may occur. Then, the user feedback management unit 150 generates feedback information from the human-robot interaction in operation S13. The robot 100 repeats these steps periodically to select a service application suitable for the user, and provides the service to be provided by the service application through the service representation device 300.

As described above, with the device and method of providing a service application using a robot in accordance with the embodiment of the present invention, service applications, which are required for service domains such as education, silver care, care for the aged, housing, company, and sightseeing, capable of utilizing a robot are produced and distributed through a service application description language including metadata, a service application suitable for a user is searched by recognizing surrounding circumstances which change in real time along with the movement of the robot, and the service is provided through a service representation device, thereby increasing user satisfaction for a service application and providing a service application capable of meeting changing circumstances. Furthermore, information generated by the human-robot interaction is used as feedback information, whereby as well as evaluation for use, such as the number of downloads, user satisfaction, and user preference of a service application, environments and circumstances required for the service application, and experience can be shared among the users. Therefore, it is possible to improve the utilization values of service applications and to use service applications in connection with different service domains so as to allow an application to various service domains.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for providing a service application using a robot, the device comprising:
a sensing unit configured to generate environmental sensing information on the surrounding of a moving path of the robot and user state information;
a user circumstance determination unit configured to determine the circumstance and intention of a user through the environmental sensing information and the user state information to generate user recognition information, and searches and downloads a service application in accordance with the user recognition information;
a service provision unit configured to search service representation devices around the moving path of the robot and migrate a service corresponding to the service application to at least one of the searched service representation devices; and
a user feedback management unit configured to manage feedback information corresponding to an interaction between the user and the robot (a human-robot interaction) while the service is being provided through the service representation device.

2. The apparatus of claim 1, wherein the user circumstance determination unit is configured to search the service application on the basis of metadata described in the service application.

3. The apparatus of claim 2, wherein the metadata comprises the domain of the service, device information relating to a device to be supported by the service application, content information relating to content included in the service application, execution information of the service, or the feedback information.

4. The apparatus of claim 2, wherein the user circumstance determination unit is configured to create a scenario of the human-robot interaction in accordance with the user recognition information and searches the service application on the basis of metadata.

5. The apparatus of claim 2, wherein the service provision unit is configured to search service representation devices corresponding to the service application in accordance with connection information and device information of the service representation devices on the basis of metadata.

6. The apparatus of claim 5, wherein the service provision unit is configured to compare and analyze the metadata and the device information of the service representation devices and selects the service representation device to which the service is provided.

7. The apparatus of claim 1, wherein the user feedback management unit is configured to manage a user response generated by the human-robot interaction and usability evaluation as the feedback information for the service application.

8. A method of providing a service application using a robot, the method comprising:
generating environmental sensing information on the surrounding of a moving path of the robot and user state information;
determining the circumstance and intention of a user through the environmental sensing information and the user state information to generate user recognition information;
searching and downloading a service application in accordance with the user recognition information;
searching service representation devices around the moving path of the robot;
migrating a service corresponding to the service application to at least one of the searched service representation devices; and
managing feedback information corresponding to an interaction between the user and the robot (a human-robot interaction) while the service is being provided through the service representation device.

9. The method of claim 8, wherein said searching a service application comprises:
searching the service application using metadata described in the service application.

10. The method of claim 9, wherein said searching a service application comprises:
creating a scenario of the human-robot interaction in accordance with the user recognition information on the basis of metadata.

11. The method of claim 9, wherein said searching service representation devices comprises:
searching service representation devices corresponding to the service application in accordance with connection information and device information of the service representation devices on the basis of the metadata.

12. The method of claim 11, wherein said migrating a service comprises:
comparing and analyzing the metadata and the device information of the service representation devices; and
selecting a service representation devices to which the service is provided.

13. The method of claim 8, wherein the feedback information comprises a user response generated by the human-robot interaction and usability evaluation.
